(19) United States
(12) Patent Application Publication
(10) Pub. No.: US 2023/0398576 A1
(43) Pub. Date: Dec. 14, 2023

(54) METHOD FOR IDENTIFYING OBJECT TO BE SORTED, SORTING METHOD, AND SORTING DEVICE

(71) Applicant: SATAKE CORPORATION, Chiyoda-ku, Tokyo (JP)

(72) Inventors: Masaaki SADAMARU, Chiyoda-ku, Tokyo (JP); Tomoyuki MIYAMOTO, Chiyoda-ku, Tokyo (JP); Shinya HARADA, Chiyoda-ku, Tokyo (JP)

(73) Assignee: SATAKE CORPORATION, Chiyoda-ku, Tokyo (JP)

(21) Appl. No.: 18/034,091

(22) PCT Filed: Nov. 9, 2021
(86) PCT No.: PCT/JP2021/041237

§ 371 Date: Apr. 27, 2023

(30) Foreign Application Priority Data
Nov. 11, 2020 (JP) 2020-188317

(51) Int. Cl. B07C 5/10; G06V 10/26; G06V 10/77; G06V 20/68; G06T 7/11; G06T 7/00; G06T 7/194; G06V 20/50; G06V 10/20

(52) U.S. Cl. CPC B07C 5/10; G06V 10/26; G06V 10/77; G06V 20/68; G06T 7/11; G06T 7/0004; G06T 7/194; G06V 20/50; G06V 10/255; G06T 2207/20081; G06T 2207/20021; G06V 2201/06; G06T 2207/30128

(57) ABSTRACT

The present invention includes a conveyance step of conveying an object to be sorted, an image information acquisition step of, at least either during the conveyance step or after the conveyance step, acquiring image information on the object to be sorted, and dividing the image information into a plurality of pieces of cell data, and an identification step of identifying the object to be sorted based on the cell data and a learning model trained by inputting learning information concerning the object to be sorted, in which the learning information at least includes good part information, defective part information, and background information concerning the object to be sorted, and the good part information at least includes contour information on the object to be sorted.

### TECHNICAL FIELD

The present invention relates to a method for identifying an object to be sorted, a sorting method, and a sorting device that enable an object to be sorted which is a target for sorting to be identified and sorted.

### BACKGROUND ART

A conventional optical sorter emits light in optical detection means to a sorting target being conveyed by a belt conveyor, receives reflected light from the sorting target by a line sensor or the like, and determines a defective product based on light detected by the line sensor. Here, objects to be sorted which are targets for sorting include beans such as black soybean and red kidney bean, seeds such as black sesame seeds, dried short noodles such as dried macaroni and dried penne, resin pellets, and the like. Then, the optical sorter sorts an object to be sorted having been determined as a defective product with ejected air. In the optical detection means included in the optical sorter, emission devices that each emit light in the vertical direction to an optical detection position on a falling trajectory along which objects to be sorted are released are installed. Further, in the optical detection means, light receiving sensors such as line sensors that each receive reflected light from an object to be sorted at the above-described optical detection position in the vertical direction are installed.

As a conventional technology related to the above-described optical sorter, Patent Literature 1, for example, discloses causing a sorter to learn a three-dimensional color distribution pattern concerning each wavelength component of R (red), G (green), and B (blue) of objects to be sorted including non-defective products, defective products, and foreign matters prepared in advance, and sorting the objects to be sorted effectively utilizing three-dimensional color space information on RGB colors close to human eyes.

### CITATION LIST

### Patent Literature

### [Patent Literature 1]

Japanese Patent No. 6037125

### SUMMARY OF INVENTION

### Technical Problem

The above-described device can sort objects to be sorted with high accuracy in accordance with color information. However, there is a problem in that a defective product with a shape such as irregularities, a crack, a tear, or crinkles appearing on its surface cannot be sorted merely with the color information. There is a need in the market for optical sorters that can identify a surface shape such as irregularities, a crack, or a tear on the surface of an object to be sorted and sort a grain having a defective “surface shape”.

In view of such problems, the present invention has an objective to provide a method for identifying an object to be sorted, a sorting method, and a sorting device that enable an object to be sorted to be identified and sorted.

### Solution to Problem

An embodiment of the present invention is a method for identifying an object to be sorted, including:
a conveyance step of conveying an object to be sorted;
an image information acquisition step of, at least either during the conveyance step or after the conveyance step, acquiring image information on the object to be sorted, and dividing the image information into a plurality of pieces of cell data; and
an identification step of identifying the object to be sorted based on the cell data and a learning model trained by inputting learning information concerning the object to be sorted, in which
the learning information at least includes good part information, defective part information, and background information concerning the object to be sorted, and
the good part information at least includes contour information on the object to be sorted.

In another embodiment of the present invention,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information.

Another embodiment of the present invention includes:
a conveyance step of conveying an object to be sorted;
an image information acquisition step of, at least either during the conveyance step or after the conveyance step, acquiring image information on the object to be sorted, and dividing the image information into a plurality of pieces of cell data;
an identification step of identifying the object to be sorted based on the cell data and a learning model trained by inputting learning information concerning the object to be sorted; and
a sorting step of sorting the object to be sorted based on identification information obtained in the identification step, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information.

Another embodiment of the present invention is a device for sorting an object to be sorted, including:
conveyance means in which an object to be sorted is conveyed;
image information acquisition means in which, at least either during conveyance or after conveyance in the conveyance means, image information on the object to be sorted is acquired, and the image information is divided into a plurality of pieces of cell data;
identification means in which the object to be sorted is identified based on the cell data and a learning model trained by inputting learning information concerning the object to be sorted; and
sorting means in which the object to be sorted is sorted based on identification information obtained in the identification means, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information.

In another embodiment of the present invention,
the sorting means includes a plurality of ejectors operated based on the identification information, and
at least one of the number or an arrangement of the ejectors and the cell data have a predetermined relationship.

### Advantageous Effect of Invention

By providing a configuration for identifying an object to be sorted by a learning model, highly accurate shape sorting of an object to be sorted can be performed at the same time in addition to conventional color sorting.

### BRIEF DESCRIPTION OF DRAWINGS

FIG. 1 is an overall perspective view of a sorting device according to an embodiment of the present invention.

FIG. 2 is a cross-sectional view of the sorting device according to an embodiment of the present invention.

FIG. 3 is a schematic diagram representing the vicinity of an optical detection unit of the sorting device according to an embodiment of the present invention.

FIG. 4 is an outlined hardware configuration diagram of the sorting device according to an embodiment of the present invention.

FIG. 5 is a block diagram showing functions of a signal processing unit included in the sorting device according to an embodiment of the present invention.

FIG. 6 is a diagram showing an example of image data acquired from a signal detected by the optical detection unit.

FIG. 7 is a block diagram showing functions of a surface shape determination unit included in the sorting device according to an embodiment of the present invention.

FIG. 8 is a diagram showing an example of image data divided into cell data.

FIG. 9 is a diagram showing an example of supervised data to be used in learning.

FIG. 10 is an outlined hardware configuration diagram of a mechanical learning device.

FIG. 11 is a block diagram showing functions of the mechanical learning device.

FIG. 12 is a diagram describing an input proportion per cell data of an object to be sorted in machine learning.

FIG. 13 is a diagram describing an input proportion per cell data of an object to be sorted in machine learning.

### DESCRIPTION OF EMBODIMENT

An embodiment of a method for identifying an object to be sorted, a sorting method, and a sorting device of the present invention will be described next with reference to the accompanied drawings.

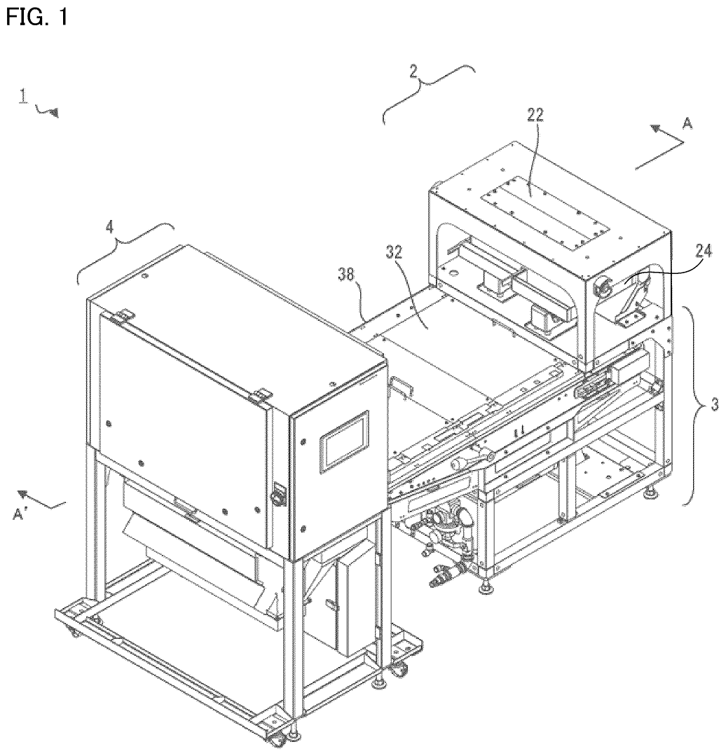

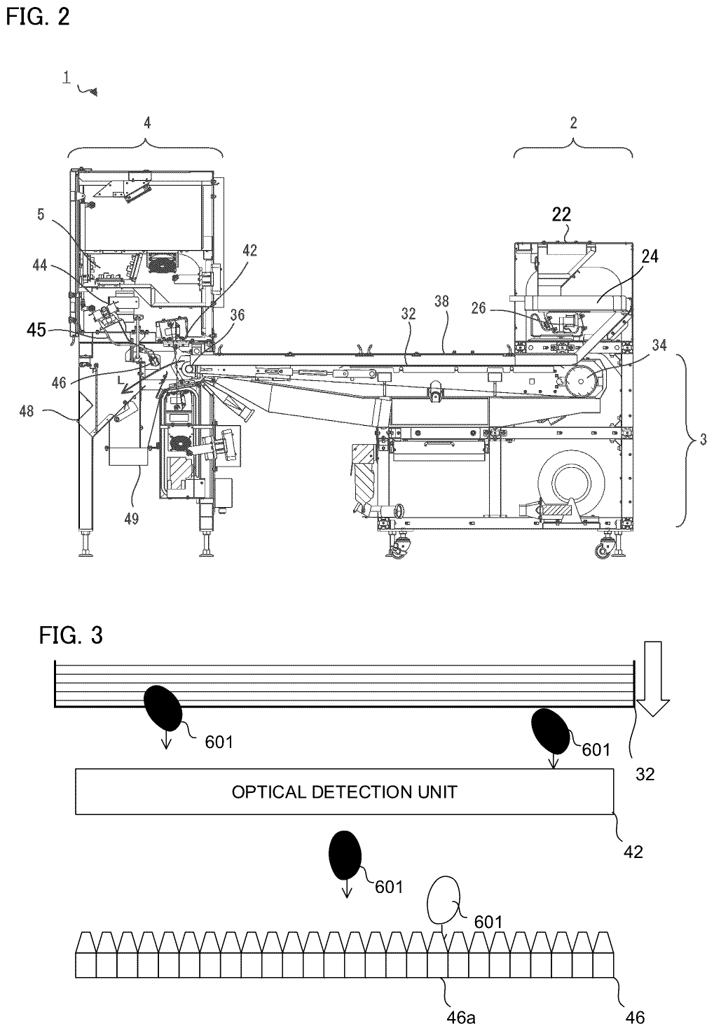

FIG. 1 shows a front-side overall perspective view of an optical sorter 1 corresponding to the sorting device of the present invention, and FIG. 2 shows an A-A cross-sectional view in FIG. 1.

The optical sorter 1 of the present embodiment is suitable for sorting various bean raw materials (such as peanut, almond, soybean, adzuki bean, kidney bean, black soybean, and red kidney bean), seeds (such as black sesame seeds, morning glory seeds, and sunflower seeds), short dried noodles (such as dried macaroni, dried penne, and dried riso), resin pellets, and the like.

The optical sorter 1 includes a supply section 2 that supplies objects to be sorted to a conveying section 3, the conveying section 3 that conveys the objects to be sorted as supplied from the supply section 2 to an optical sorting section 4, the optical sorting section 4 that optically sorts a defective product from the objects to be sorted, and a determination processing section 5 that performs determination processing related to optical sorting.

The supply section 2 includes an inlet 22 for throwing in objects to be sorted, and a feeder 24 that supplies the conveying section 3 with the objects to be sorted having been thrown in. A bottom surface of the feeder 24 is supported by a vibration device 26, and when vibration is applied to the feeder 24 from the vibration device 26, the objects to be sorted present in the feeder 24 are moved and supplied to the conveying section 3.

The conveying section 3 includes an endless belt conveyor 32 laid over rollers 34, 36 provided rotatably in a horizontally provided machine frame 38 which is substantially cuboid, and the roller 34 communicates with a motor not shown so as to rotate at a constant speed. With such a configuration, the conveying section 3 conveys the objects to be sorted having been supplied from the supply section 2 to the optical sorting section 4 at a constant flow rate and a constant speed.

The optical sorting section 4 includes an optical detection unit 42 in the middle of a parabolic trajectory L of objects to be sorted released from a terminal end of the belt conveyor 32. The optical detection unit 42 includes an emission part that emits light to objects to be sorted having been released, and a light receiving sensor that detects light emitted from the emission part and reflected by the surface of an object to be sorted. A line sensor or the like may be used for the light receiving sensor so as to be capable of detection over a range in a depth direction in the drawing in which an object to be sorted is released. In addition, a background plate not shown to be detected as a background is installed at a position opposite to the light receiving sensor with the interposition of the parabolic trajectory L. Note that although being omitted in the drawing, two or more of the optical detection units 42 may be disposed with a shift at an upstream side and a downstream side in a flow-down direction with the interposition of the parabolic trajectory L in order to observe states of front and rear surfaces of an object to be sorted.

A plurality of ejectors 46 aligned in the depth direction in the drawing in correspondence to an inspection range of the optical detection unit 42 are installed in the vicinity of the parabolic trajectory L below the optical detection unit 42. The ejectors 46 are connected to an air compressor 44 with a blast pipe 45, and operate to eject high-pressure air by controlling a solenoid valve (not shown) provided for each of the ejectors 46. A non-defective product outlet gutter 48 is provided on the parabolic trajectory L below the ejectors 46, and a defective product outlet gutter 49 that receives a defective product blown by the ejectors 46 and rejected is provided on one side of the non-defective product outlet gutter 48.

The determination processing section 5 determines whether each object to be sorted is a non-defective product or a defective product in accordance with a surface state (color and surface shape) of the object to be sorted detected by the optical detection unit 42. Then, in a case where there is an object to be sorted having been determined as a defective product, one of the ejectors 46 that corresponds to the position of the detected object to be sorted is actuated with a delay by a predetermined time set in advance, and the object to be sorted is rejected by blowing into the defective product outlet gutter 49.

FIG. 3 is a schematic diagram in a case of viewing the periphery of the optical detection unit 42 from above the optical sorter 1. As shown in FIG. 3, in a conveyance step, the belt conveyor 32 conveys an object to be sorted 601 in a direction of an open arrow and releases the object to be sorted 601. Then, the object to be sorted 601 released from a terminal end of the belt conveyor 32 forms a parabola while moving in an arrow direction, and drops in the downward direction in FIG. 3. At this time, the object to be sorted 601 passes through a detection range of the optical detection unit 42. At the downstream of the flow-down direction of the object to be sorted 601, the plurality of ejectors 46 are aligned with a width substantially identical to a width of the detection range by the optical detection unit 42. In a case where there is an object to be sorted determined as a defective product (for example, the object to be sorted 601 shown in white in FIG. 3), the determination processing section 5 actuates, in a sorting step, one of the ejectors 46 (an ejector 46a in FIG. 3) that ejects high-pressure air to a position through which the object to be sorted 601 passes among the plurality of ejectors 46 that configure sorting means, thereby blowing the object to be sorted 601 which is a defective product into the defective product outlet gutter 49.

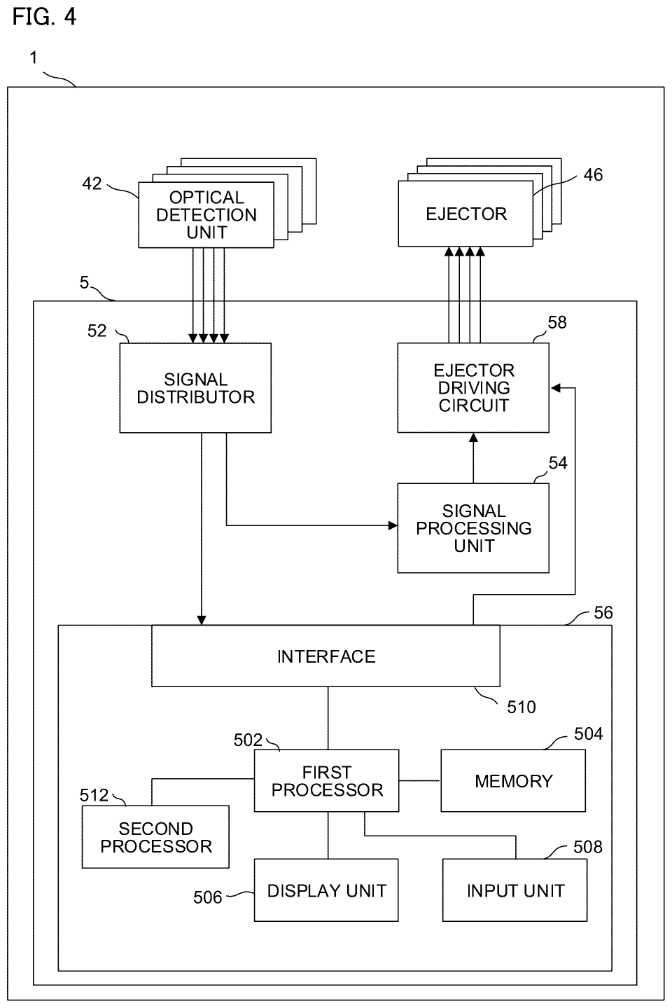

FIG. 4 is an outlined configuration diagram of the determination processing section 5 included in the optical sorter 1 according to an embodiment. The determination processing section 5 included in the optical sorter 1 according to the present embodiment is configured by a signal processing circuit, a computer, and the like installed in the optical sorter 1. Note that FIG. 4 only shows a configuration of the determination processing section 5 and the optical detection unit 42 and the ejectors 46 connected to the determination processing section 5, and other components are omitted.

The determination processing section 5 according to the present embodiment at least includes a signal distributor 52 that distributes a signal detected by the optical detection unit 42, a signal processing unit 54 that receives as input a signal distributed by the signal distributor 52 to determine whether an object to be sorted is a non-defective product or a defective product based on color information, a surface shape determination unit 56 that receives as input a signal distributed by the signal distributor 52 to determine whether the object to be sorted is a non-defective product or a defective product based on the surface shape, and an ejector driving circuit 58 that controls driving of the ejectors as the sorting means.

The signal distributor 52 is configured by a common distribution circuit that distributes a sensor signal. The signal distributor 52 distributes a signal input from the optical detection unit 42 into at least two signals, and outputs the respective distributed signals to the signal processing unit 54 and the surface shape determination unit 56.

The signal processing unit 54 is configured by a FPGA (field-programmable gate array) or the like as a circuit that performs signal processing. The signal processing unit 54 determines whether the object to be sorted is a non-defective product or a defective product based on color information, based on the signal from the optical detection unit 42 input from the signal distributor 52. Then, the signal processing unit 54 outputs identification information to the ejector driving circuit 58 via a defective product information combining mechanism 550 based on a result of determination about the object to be sorted based on the color information. The ejector driving circuit 58 instructs to drive one of the ejectors 46 that corresponds to the position at which a defective product is detected. Similarly, the surface shape determination unit 56 outputs identification information to the ejector driving circuit 58 via the defective product information combining mechanism 550 which will be described later based on a result of determination about a non-defective product or a defective product based on the surface shape. Accordingly, the ejector driving circuit 58 instructs to drive one of the ejectors 46 that corresponds to the position at which a defective product is detected based on the identification information input from the signal processing unit 54 and the surface shape determination unit 56. In other words, the signal processing unit 54 and the surface shape determination unit 56 instruct the ejector driving circuit 58 that functions as the sorting means for an object to be sorted such that the ejector 46 is actuated with a delay by a predetermined time set in advance after the determination processing about a defective product is performed. Adjustment of the delay time may be set while actually operating the optical sorter 1 experimentally and confirming with how much delay a determined defective product reaches an ejection position of the ejector 46.

The surface shape determination unit 56 is configured by a computer. The surface shape determination unit 56 includes a first processor 502 such as a CPU that performs control processing related to operation of the optical sorter 1 and performs the above-described determination processing about whether an object to be sorted is a non-defective product or a defective product, and a memory 504 that at least temporarily stores a system program that defines a control processing step and data acquired from the optical detection unit 42 and the like.

The first processor 502 controls each component of the optical sorter 1 in accordance with the system program. The surface shape determination unit 56 may include a second processor 512 for executing processing related to machine learning, separately from the first processor 502. Although a CPU, a FPGA, or the like may be used for the second processor 512, it is preferably desirable to adopt a GPU or the like that is capable of processing a large amount of signals in parallel. Adopting the GPU increases a surface shape estimation processing speed, which is more preferable from the perspective of improving a sorting capability. The memory 504 of the surface shape determination unit 56 is configured by a ROM (read only memory), a RAM (random access memory), a flash memory, a magnetic storage device, and the like, for example, and stores in advance the system program and the like, and also stores data acquired from the outside via an input unit 508, an interface 510, and the like, various programs, and the like.

A display unit 506 displays data and a program stored in the memory 504 based on control exerted by the first processor 502. The display unit 506 may be configured by a liquid crystal display, an organic EL display, a liquid crystal touch panel, or the like, for example. An input unit 508 is configured by a keyboard, a pointing device, a touch panel, and the like, and receives an instruction, data, and the like based on an operation by a user. An interface 510 receives data detected by the optical detection unit 42 based on control exerted by the first processor 502. In addition, the interface 510 transmits data to the signal processing unit 54 based on control exerted by the first processor 502.

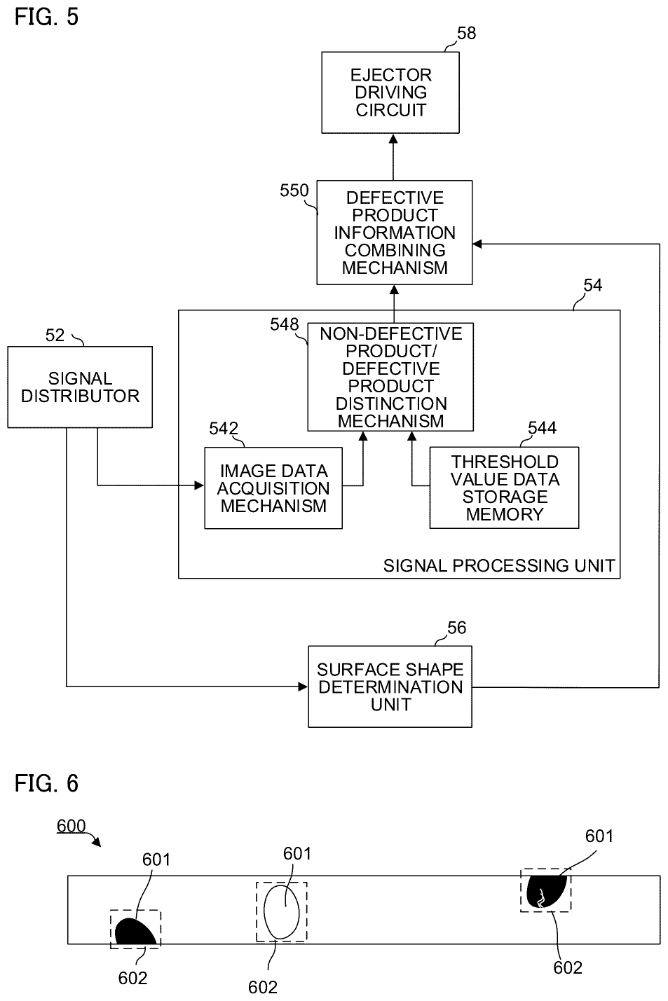

FIG. 5 shows functions included in the signal processing unit 54 according to the present embodiment by a block diagram. Each block of an image data acquisition mechanism 542, a threshold value data storage memory 544, a non-defective product/defective product distinction mechanism 548, and a defective product information combining mechanism 550 shown in FIG. 5 indicates a function provided by each circuit mechanism configured on the signal processing unit 54 as a block. The signal processing unit 54 includes the image data acquisition mechanism 542 that temporarily stores a signal acquired from the signal distributor 52 as image data, the threshold value data storage memory 544 that stores threshold value data for determining whether the acquired image data is a non-defective product or a defective product, and the non-defective product/defective product distinction mechanism 548 that distinguishes between a non-defective product and a defective product. The signal distributor 52 has one end electrically connected to the image data acquisition mechanism 542 in the signal processing unit 54. In addition, the non-defective product/defective product distinction mechanism 548 and the interface 510 of the surface shape determination unit 56 are electrically connected to the defective product information combining mechanism 550, in which defective product information is combined. Further, an electric connection is made from the defective product information combining mechanism 550 to the ejector driving circuit 58.

The threshold value data storage memory 544 stores threshold value data to be a border between a non-defective product region and a defective product region on a three-dimensional color space automatically calculated using samples of image data on each of a non-defective product among objects to be sorted prepared in advance by an operator, a defective product among the objects to be sorted, and a foreign matter. The non-defective product region is a distribution region obtained when the color of image data obtained by imaging a non-defective product among the objects to be sorted is plotted on the three-dimensional color space, and the defective product region is a distribution region obtained when the color of image data obtained by imaging a defective product among the objects to be sorted and a foreign matter is plotted on the three-dimensional color space. A color distribution pattern of the non-defective product and a color distribution pattern of the defective product are generated by performing a color analysis on image data obtained by imaging a plurality of samples prepared in advance. From these color distributions, a cluster of color patterns of non-defective products and a cluster of color patterns of defective products are formed, and the border between the respective clusters as formed is calculated to calculate a threshold value for distinguishing between a non-defective product and a defective product. The threshold value calculated in this manner is stored in advance in the threshold value data storage memory 544 as threshold value data. Note that since the method for calculating the threshold value has already been sufficiently known by Japanese Patent No. 6037125, for example, explanation in the description of the present application is omitted.

When sorting an object to be sorted, a signal detected by the optical detection unit 42 and distributed by the signal distributor 52 is acquired as image data by the image data acquisition mechanism 542. FIG. 6 shows an example of image data 600 acquired from the signal detected by the optical detection unit 42. As illustrated in FIG. 6, the image data 600 is obtained by imaging over a range in the depth direction in FIG. 2, which is a width direction in which the belt conveyor 32 releases a sorting target. The image data acquisition mechanism 542 performs image processing on the acquired image data 600, extracts partial images 602 (dotted frames in the drawing) in which objects other than the background are reflected, and outputs the respective extracted partial images 602 to the non-defective product/defective product distinction mechanism 548 together with information related to their positions in the image data.

The non-defective product/defective product distinction mechanism 548 analyzes the colors of the respective extracted partial images 602 for spread on the three-dimensional color space and performs a comparison with the threshold value stored in the threshold value data storage memory 544. In a case where the color of the partial image 602 falls within the non-defective product region, the non-defective product/defective product distinction mechanism 548 distinguishes that the sorting target reflected in the partial image 602 is a non-defective product. In a case where the color of the partial image 602 falls within the defective product region, the non-defective product/defective product distinction mechanism 548 distinguishes that the sorting target reflected in the partial image 602 is a defective product (or a foreign matter). Then, the non-defective product/defective product distinction mechanism 548 outputs a defective product position signal indicating the position corresponding to the partial image 602 in which the defective product is reflected (the position in the depth direction of the optical detection unit 42 in FIG. 2) to the defective product information combining mechanism 550.

The defective product information combining mechanism 550 instructs the ejector driving circuit 58 to drive (instantaneously open the solenoid valve to eject high-pressure air) one of the ejectors 46 that corresponds to a position indicated by each of the defective product position signal output from the non-defective product/defective product distinction mechanism 548 and a defective product position signal output from the surface shape determination unit 56 which will be described later. At this time, the defective product information combining mechanism 550 instructs the ejector driving circuit 58 to drive the ejector 46 with a delay just by a delay time set in advance.

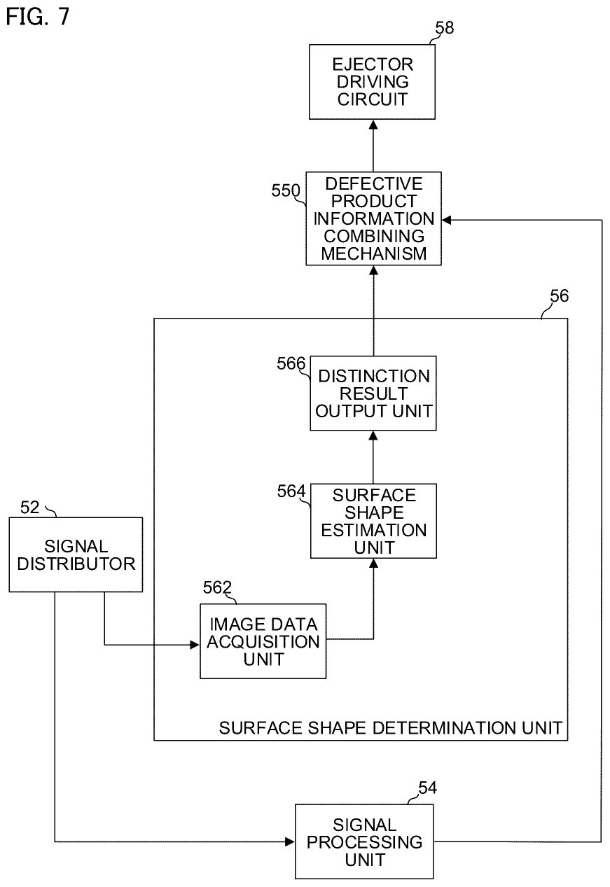

FIG. 7 is a block diagram of functions included in the surface shape determination unit 56 of the optical sorter 1 according to the present embodiment. Each block of an image data acquisition unit 562, a surface shape estimation unit 564, and a distinction result output unit 566, shown in FIG. 7, is shown as a block of a function included in the surface shape determination unit 56. Each of these functions is achieved by the first processor 502 included in the surface shape determination unit 56 controlling each component of the memory 504, the display unit 506, the input unit 508, and the interface 510 (further, the second processor 512 according to necessity).

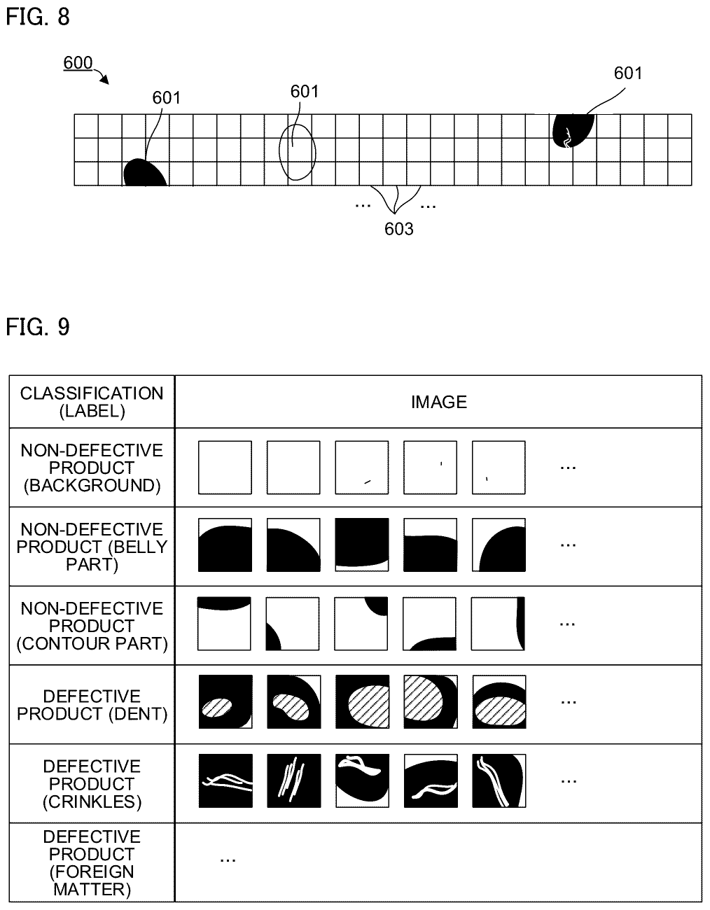

The image data acquisition unit 562 acquires, as image data, a signal acquired from the signal distributor 52. The image data acquired by the image data acquisition unit 562 is similar to the image acquired by the signal processing unit 54. Subsequently, in an image information acquisition step, the image data acquisition unit 562 divides the acquired image data into pieces of cell data which are unit images by which surface shape estimation is to be performed by the surface shape estimation unit 564. FIG. 8 is an example in which image data is divided into pieces of cell data. As shown in FIG. 8, the image data 600 is divided into pieces of cell data 603 which are lattice-shaped partial images. In division into the cell data 603, division may be performed in accordance with the number of the ejectors 46 and their arrangement form, and such a configuration can simplify operation processing of the ejectors 46. Note that in the example shown in FIG. 8, the image data is divided into 26 in the lateral direction and divided in the longitudinal direction in conformity with the width when divided in the lateral direction (so as to have a square shape, for example). By dividing the image data into cell data, a total time required for surface shape estimation processing for the respective pieces of cell data is shorter than a time in a case of spending a time totally for the estimation processing without dividing the image data. Note that the image data acquisition unit 562 may perform image processing (preprocessing) such as normalization on the image data according to necessity so as to facilitate the estimation processing by the surface shape estimation unit 564.

The surface shape estimation unit 564 uses the cell data 603 input from the image data acquisition unit 562 as input data to perform estimation processing with a multi-layer neural network generated by using a machine learning technology. The surface shape estimation unit 564 stores, as a learning model, a learning result (such as parameters and weighting of the neural network, for example) obtained by learning a correlation among the cell data 603 in which the object to be sorted 601 is reflected, the cell data 603 in which a foreign matter is reflected, and the cell data 603 in which the background is reflected and labels indicating a non-defective product including the background and a defective product including a foreign matter. For example, in the case of utilizing the multi-layer neural network, the multi-layer neural network can be configured by all coupled layers of a convolution layer and a pooling layer. The surface shape estimation unit 564 inputs the cell data 603 received from the image data acquisition unit 562 to this model, identifies whether the object to be sorted is a non-defective product, a defective product, or the like, and determines output from the model as an estimation result (an identification step). Although the surface shape estimation unit 564 may be achieved by performing the estimation processing in the first processor 502 such as a CPU, it is desirable to prepare the second processor 512 such as a GPU having a high parallel processing capability where possible and perform the estimation processing on the second processor 512. The estimation processing by the surface shape estimation unit 564 should be completed at least before detection of the object to be sorted 601 by the optical detection unit 42 and arrival at the position at which the ejector 46 ejects high-pressure air. It is therefore suitable to use the second processor 512 such as a GPU capable of processing the estimation processing by machine learning at high speed although the introduction cost is high.

In learning of the model stored in the surface shape estimation unit 564, a plurality of pieces of supervised data are generated in which at least any of the cell data 603 in which part of the object to be sorted 601 is reflected, the cell data 603 in which part of a foreign matter is reflected, and the cell data 603 in which the background is reflected is used as input data, and labels classified by a non-defective product, a defective product, and the like are used as output data (label data). At this time, rather than simply classifying by two labels of a non-defective product and a defective product, it is desirable to generate supervised data to be learning information using classifications of the background and portions of the object to be sorted 601 for the label of a non-defective product. In addition, it is more suitable to generate supervised data further classified by labels of the types of defects in defective products and the types of foreign matters according to necessity.

As illustrated in FIG. 9, for example, the cell data 603 to be good part information in which a non-defective product is reflected can be provided with different labels such as a “belly part” and a “contour part” (belly part information and contour information) based on a proportion occupied by an object to be sorted in an image in addition to the cell data 603 to be background information in which only the background is reflected. In addition, the cell data 603 to be defective part information in which a defective product is reflected can be provided with different labels such as a “dent” or “crinkles” depending on content of the defect. By generating such supervised data and performing learning, the estimation processing is improved in accuracy as compared with a case of using supervised data simply classified with labels of a non-defective product (including the background) and a defective product. In other words, in a case of simply separating into non-defective products and defective products, the number of pieces of the cell data 603 in which non-defective products (and the background) are reflected will be extremely larger than the number of pieces of the cell data 603 in which defective products are reflected. Then, when supervised data is generated based on such data and learning is performed, a model having a low accuracy of distinguishing defective products will be created. On the other hand, when the number of pieces of the cell data 603 in which non-defective products are reflected is reduced in conformity with the number of pieces of the cell data 603 in which defective products are reflected, a model having a low accuracy of distinguishing non-defective products will be created. Taking such circumstances into consideration, the present invention finely classifies non-defective products, and further, finely classifies defective products as well according to necessity, to generate supervised data, thus maintaining the distinction accuracy high.

The distinction result output unit 566 outputs a defective product position signal indicating the position of the cell data 603 in which a defective product is reflected in image data to the defective product information combining mechanism 550 included in the signal processing unit 54 based on a result of the estimation processing by the surface shape estimation unit 564.

The optical sorter 1 according to the present embodiment including the above-described configuration not only performs sorting of a non-defective product and a defective product simply based on the color of an object to be sorted, but also enables sorting of a non-defective product and a defective product to be performed based on the surface shape of the object to be sorted. The configuration of distinguishing between a non-defective product and a defective product based on the surface shape of the object to be sorted can be used in a form added to the configuration of distinguishing between a non-defective product and a defective product based on the color according to the conventional art. By distributing an image detected by the optical detection unit 42 into the signal processing unit 54 according to the conventional art and the surface shape determination unit 56 according to the present embodiment using the signal distributor 52, and combining the result of distinguishing between a non-defective product and a defective product based on the surface shape obtained by the surface shape determination unit 56 in a distinction result obtained by the signal processing unit 54, distinction based on the surface shape can be performed while making use of the conventional art of the optical sorter 1.

Hereinafter, a mechanical learning device that learns the model of the multi-layer neural network stored in the surface shape determination unit 56 included in the optical sorter 1 will be described.

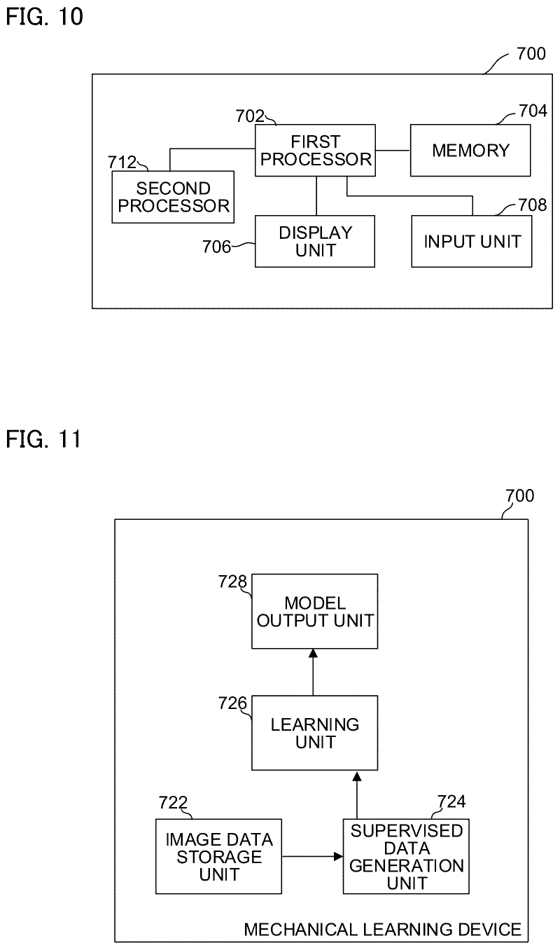

FIG. 10 is an outlined hardware configuration diagram of the mechanical learning device.

A mechanical learning device 700 is configured by a computer. The mechanical learning device 700 includes a first processor 702 such as a CPU, and a memory 704 that at least temporarily stores a system program, supervised data to be used in learning, parameters of the multi-layer neural network, and the like.

The first processor 702 controls each component of the mechanical learning device 700 in accordance with the system program. The mechanical learning device 700 may include a second processor 712 for executing processing related to machine learning separately from the first processor 702. The second processor 712 may be, for example, a GPU capable of processing a large amount of signals in parallel, or the like. Since the surface shape estimation processing speed increases because of the GPU, employment of the GPU is preferable from the perspective of improving the sorting capability. The memory 704 of the mechanical learning device 700 is configured by, for example, a ROM (read only memory), a RAM (random access memory), a flash memory, a magnetic storage device, and the like, and stores data acquired from the outside via an input unit 708 or the like, various programs, and the like in addition to storing the system program and the like in advance.

A display unit 706 displays data and the program stored in the memory 704 based on control exerted by the first processor 702. The display unit 706 may be configured by a liquid crystal display, an organic EL display, a liquid crystal touch panel, or the like, for example. The input unit 708 is configured by a keyboard, a pointing device, a touch panel, and the like, and receives an instruction, data, and the like based on an operation made by a user.

FIG. 11 is a block diagram of functions included in the mechanical learning device 700. Each block of an image data storage unit 722, a supervised data generation unit 724, a learning unit 726, and a model output unit 728 shown in FIG. 11 is shown as a block of a function included in the mechanical learning device 700. Each of these functions is achieved by the first processor 702 included in the mechanical learning device 700 controlling each component of the memory 704, the display unit 706, and the input unit 708 (and the second processor 712 according to necessity).

The image data storage unit 722 stores cell data which is partial image data on an object to be sorted which is a learning target. In learning of the model of the invention of the present application, cell data in which at least part of an object to be sorted is reflected and cell data in which the background is reflected are used. The cell data may be generated based on image data obtained by experimentally throwing in an object to be sorted in the optical sorter 1 and imaging by the optical detection unit 42, and may be acquired by the mechanical learning device 700 via an external memory device such as a USB not shown.

The supervised data generation unit 724 generates supervised data obtained by classifying cell data on an object to be sorted as stored in the image data storage unit 722 and providing a label. The supervised data generation unit 724 may perform image analysis on the cell data, for example, and automatically perform classification based on the proportion occupied by the object to be sorted in the cell data (in a case where the proportion occupied by the object to be sorted is less than or equal to 30% of the cell data, for example, it is determined as a contour part), the shape of the object to be sorted reflected in the cell data (if a hole portion is reflected in a case of macaroni, for example, it is determined as an end part), and the like to provide the cell data with a label. In addition, the supervised data generation unit 724 may sequentially display cell data on the display unit 706, and provide the cell data with a label by an operator operating the input unit 708 to input a classification.

In machine learning with supervised data, it is usually desirable to equalize the number of images to be used in learning for each label. However, cell data on objects to be sorted as collected includes the background, a non-defective product (contour part) including a large part of the background, a non-defective product (belly part) with a small part of the background, and a defective product including a foreign matter. In this manner, in a case of using cell data including various types of information as supervised data for machine learning, the proportion of the number of pieces of cell data for each classified label varies depending on the size of an object to be sorted, the size of a characteristic part, and a cell size of cell data. Thus, the present embodiment determines the proportion of the number of pieces of supervised data per label based on the proportion of the number of pieces of cell data to improve the accuracy in deduction processing, rather than equalizing the number of pieces of cell data, that is, the number of images, for each label.

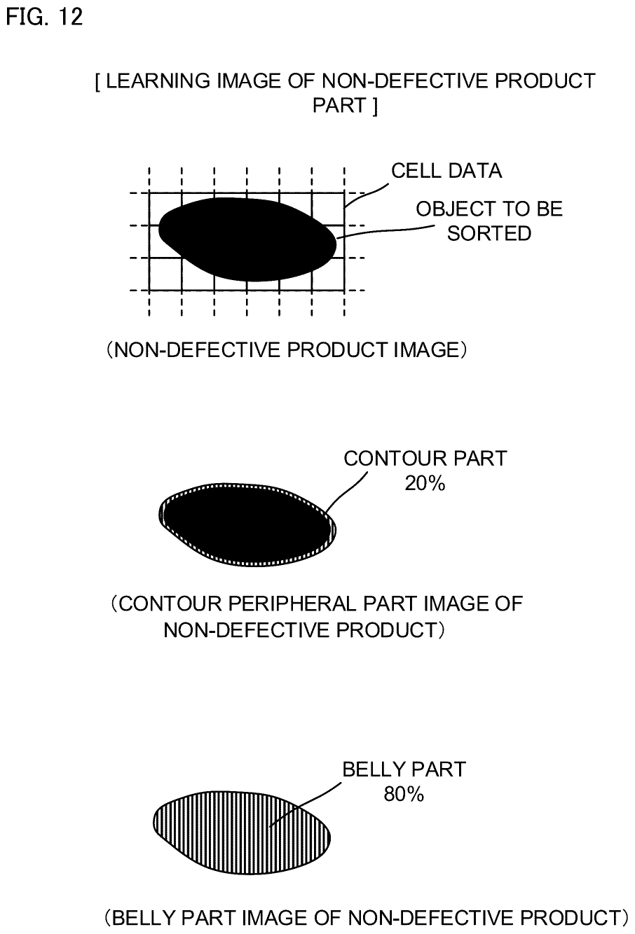

As shown in FIG. 12, for example, in a case where the size of the object to be sorted is larger than the cell size of cell data like the red kidney bean, the following can be performed when determining a ratio of the number of images of supervised data to be learning information for use in machine learning. In other words, it can be determined that there may be a small number of images for the background since the background has few patterns. In addition, it is better to finely classify a non-defective product into the contour part (contour information) and the belly part (belly part information) since the size of the object to be sorted is large with respect to the cell size of the cell data. The contour part can include a contour peripheral part of a non-defective product as shown in FIG. 12, and the belly part can include a belly part of the non-defective product as shown in FIG. 12. In addition, as shown in the drawing, an area around the contour part is approximately 20% and an area of the belly part is approximately 80% of the whole area of the object to be sorted, so that the contour part (contour information) has a smaller proportion than the proportion of the belly part (belly part information). Consequently, the ratio can be set such that the number of images of the belly part (belly part information) is larger than the number of images of the contour part (contour information), and can be used as an input proportion of learning information.

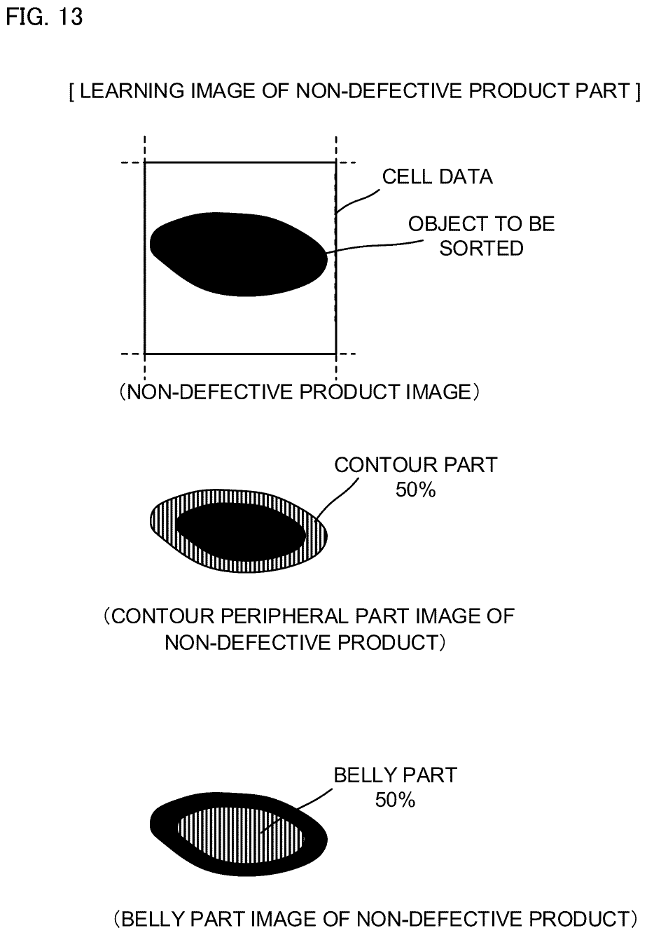

On the other hand, in a case where the size of an object to be sorted is smaller than the cell size of the cell data and the object to be sorted falls within a single piece of cell data as shown in FIG. 13, the position at which objects to be sorted are released from a chute or the belt conveyor is regulated and imaging is performed such that an object always falls within a single piece of cell data, or inversely, processing of adjusting the position of cell data can be performed such that an object to be sorted falls within the single piece of cell data. Such a configuration brings about a merit that it is not necessary to label a non-defective product into the contour part and the belly part, but is not necessarily efficient due to the labor of regulating the position of releasing objects to be sorted and complicated processing for sorting objects to be sorted for a short time. Consequently, it is more preferable to regularly divide image data into cell data for processing, and to label a non-defective product into the contour part (contour information) and the belly part (belly part information), similarly to the foregoing. In addition, as shown in the drawing, both the periphery of the contour part and the belly part each become approximately 50% of the whole area of the object to be sorted, so that the ratios of the contour part and the belly part become an equivalent proportion. Consequently, the number of images of the contour part (contour information) and the number of images of the belly part (belly part information) can have a comparable ratio, which can be used as an input proportion in learning information.

As described above, the input proportion of contour information and belly part information which are learning information to be used in machine learning can be defined based on a contour area in the contour information on an object to be sorted and a belly part area in the belly part information. In addition, as for the input proportion of good part information which is cell data on a non-defective product and defective part information which is cell data on a defective product, it is preferable to set a relationship of “good part information:defective part information” so as to satisfy a relational expression of “5-50:1-5” as also shown in FIG. 9. Further, considering cell data including the background alone, it is preferable to set a relationship of “background information:good part information:defective part information” so as to satisfy a relational expression of “1:10-100:2-10” as also shown in FIG. 9.

The learning unit 726 performs learning of the multi-layer neural network based on the supervised data generated by the supervised data generation unit 724. In learning of the multi-layer neural network, the multi-layer neural network may be caused to learn a correlation between input data and output data given as supervised data by adjusting the weight of each layer using publicly-known backpropagation or the like, for example. Although the learning unit 726 may be achieved by the first processor 702 such as a CPU performing learning processing, it is desirable where possible to perform estimation processing in the second processor 712 such as a GPU having a high parallel processing capability. The learning processing performed by the learning unit 726 requires a large amount of calculation processing using, as input, each pixel that configures cell data. It is therefore suitable to use the second processor 512 such as a GPU skilled in processing of handling a large amount of data in parallel although the introduction cost is high.

The model output unit 728 outputs the model of the multi-layer neural network generated by the learning unit 726 to an external memory device such as a USB not shown, for example. The model output by the model output unit 728 can be used for distinguishing whether a sorting target is a non-defective product or a defective product by loading the model into the surface shape estimation unit 564 of the optical sorter 1.

Although an embodiment of the present invention has been described so far, a specific approach for carrying out the present invention is not restricted to the aforementioned embodiment. The design, operation procedure, and the like may be modified as appropriate as long as the present invention can be carried out. For example, an auxiliary element such as a device or a circuit serving for assisting a component used in the present invention to exert a function can be added and omitted as appropriate.

The present embodiment is directed to the sorter that sorts a defective product as an object to be sorted from sorting targets, but is not limited to this, and may be applied to a sorter that sorts a non-defective product as an object to be sorted from sorting targets.

The present embodiment is directed to the sorter that conveys sorting targets by the belt conveyor, but may be applied to a sorter including such a conveying section that causes sorting targets to flow down and be conveyed through use of a chute or the like. Further, in the case of using a chute in the step of conveying objects to be sorted, a transparent part can be formed at least in part of the chute, and objects to be sorted flowing down on the transparent part can be imaged to acquire image information. In other words, image information on the objects to be sorted can also be acquired in the conveyance step without being limited to acquisition of image information after the conveyance step as in the aforementioned embodiment.

In the present embodiment, a light receiving sensor that detects light reflected by the surface of an object to be sorted is used for the optical detection unit 42, but the optical detection unit 42 is not limited to this, and a sensor capable of detecting an object to be sorted with UV rays, visible light rays, near infrared rays, and electromagnetic waves such as X-rays, and its signal component may be used.

In the present embodiment, it has been described that the ejectors 46 control the solenoid valve (not shown), but this is not necessarily a limitation, and may control a movable valve based on another operation principle. For example, ejectors including piezo valves that open/close valves through use of the piezo effect can also be used. Alternatively, ejectors of flap-type, paddle-type, vacuum-type, or the like can also be used besides the air-type that ejects high-pressure air.

In addition, the mechanical learning device 700 mentioned above may be included in a computer device separate from the optical sorter 1, but the mechanical learning device 700 may be included in the optical sorter 1.

In addition, an embodiment of the present invention can also be configured as indicated below.

An embodiment of the present invention is a method for identifying an object to be sorted, including:
a conveyance step of conveying an object to be sorted;
an image information acquisition step of, at least either during the conveyance step or after the conveyance step, acquiring image information on the object to be sorted, and dividing the image information into a plurality of pieces of cell data; and
an identification step of identifying the object to be sorted based on the cell data and a learning model trained by inputting learning information concerning the object to be sorted, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information, and an input proportion of the good part information and the defective part information satisfies a relational expression of good part information:defective part information=5-50:1-5.

Another embodiment of the present invention includes:
a conveyance step of conveying an object to be sorted;
an image information acquisition step of, at least either during the conveyance step or after the conveyance step, acquiring image information on the object to be sorted, and dividing the image information into a plurality of pieces of cell data; and
an identification step of identifying the object to be sorted based on the cell data and a learning model trained by inputting learning information concerning the object to be sorted, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information, and an input proportion of the background information, the good part information, and the defective part information satisfies a relational expression of background information:good part information:defective part information=1:10-100:2-10.

Another embodiment of the present invention includes:
a conveyance step of conveying an object to be sorted;
an image information acquisition step of, at least either during the conveyance step or after the conveyance step, acquiring image information on the object to be sorted, and dividing the image information into a plurality of pieces of cell data;
an identification step of identifying the object to be sorted based on the cell data and a learning model trained by inputting learning information concerning the object to be sorted; and
a sorting step of sorting the object to be sorted based on identification information obtained in the identification step, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information, and an input proportion of the good part information and the defective part information satisfies a relational expression of good part information:defective part information=5-50:1-5.

Another embodiment of the present invention includes:
a conveyance step of conveying an object to be sorted;
an image information acquisition step of, at least either during the conveyance step or after the conveyance step, acquiring image information on the object to be sorted, and dividing the image information into a plurality of pieces of cell data;
an identification step of identifying the object to be sorted based on the cell data and a learning model trained by inputting learning information concerning the object to be sorted; and
a sorting step of sorting the object to be sorted based on identification information obtained in the identification step, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information, and an input proportion of the background information, the good part information, and the defective part information satisfies a relational expression of background information:good part information:defective part information=1:10-100:2-10.

Another embodiment of the present invention includes:
conveyance means in which an object to be sorted is conveyed;
image information acquisition means in which, at least either during conveyance or after conveyance in the conveyance means, image information on the object to be sorted is acquired, and the image information is divided into a plurality of pieces of cell data;
identification means in which the object to be sorted is identified based on the cell data and a learning model trained by inputting learning information concerning the object to be sorted; and
sorting means in which the object to be sorted is sorted based on identification information obtained in the identification means, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information, and an input proportion of the good part information and the defective part information satisfies a relational expression of good part information:defective part information=5-50:1-5.

Another embodiment of the present invention includes:
conveyance means in which an object to be sorted is conveyed;
image information acquisition means in which, at least either during conveyance or after conveyance in the conveyance means, image information on the object to be sorted is acquired, and the image information is divided into a plurality of pieces of cell data;
identification means in which the object to be sorted is identified based on the cell data and a learning model trained by inputting learning information concerning the object to be sorted; and
sorting means in which the object to be sorted is sorted based on identification information obtained in the identification means, in which
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information, and an input proportion of the background information, the good part information, and the defective part information satisfies a relational expression of background information:good part information:defective part information=1:10-100:2-10.

### REFERENCE SIGNS LIST

1 optical sorter
2 supply section
3 conveying section
4 optical sorting section
5 determination processing section
22 inlet
24 feeder
26 vibration device
32 belt conveyor
34 roller
36 roller
38 machine frame
42 optical detection unit
44 air compressor
45 blast pipe
46 ejector
48 non-defective product outlet gutter
49 defective product outlet gutter
52 signal distributor
54 signal processing unit
56 surface shape determination unit
58 ejector driving circuit
502 first processor
504 memory
506 display unit
508 input unit
510 interface
512 second processor
542 image data acquisition mechanism
544 value data storage memory
548 defective product distinction mechanism
550 defective product information combining mechanism
562 image data acquisition unit
564 surface shape estimation unit
566 distinction result output unit
600 image data
601 sorting target
602 partial image
603 cell data
700 mechanical learning device
702 first processor
704 memory
706 display unit
708 input unit
712 second processor
722 image data storage unit
724 supervised data generation unit
726 learning unit
728 model output unit

1. A method for identifying an object to be sorted, comprising:
a conveyance step of conveying an object to be sorted;
an image information acquisition step of, at least either during the conveyance step or after the conveyance step, acquiring image information on the object to be sorted, and dividing the image information into a plurality of pieces of cell data; and
an identification step of identifying the object to be sorted based on the cell data and a learning model trained by inputting learning information concerning the object to be sorted, wherein
the learning information at least includes good part information, defective part information, and background information concerning the object to be sorted, and
the good part information at least includes contour information on the object to be sorted.

2. The method for identifying an object to be sorted according to claim 1, wherein
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information.

3. A method for sorting an object to be sorted, comprising:
a conveyance step of conveying an object to be sorted;
an image information acquisition step of, at least either during the conveyance step or after the conveyance step, acquiring image information on the object to be sorted, and dividing the image information into a plurality of pieces of cell data;
an identification step of identifying the object to be sorted based on the cell data and a learning model trained by inputting learning information concerning the object to be sorted; and
a sorting step of sorting the object to be sorted based on identification information obtained in the identification step, wherein
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information.

4. A device for sorting an object to be sorted, comprising:
conveyance means in which an object to be sorted is conveyed;
image information acquisition means in which, at least either during conveyance or after conveyance in the conveyance means, image information on the object to be sorted is acquired, and the image information is divided into a plurality of pieces of cell data;
identification means in which the object to be sorted is identified based on the cell data and a learning model trained by inputting learning information concerning the object to be sorted; and
sorting means in which the object to be sorted is sorted based on identification information obtained in the identification means, wherein
the learning information at least includes good part information, defective part information, and background information concerning the object to be sorted,
the good part information includes contour information on the object to be sorted including a large part of a background and belly part information on the object to be sorted not including or slightly including the background, and
an input proportion of the contour information and the belly part information on the object to be sorted in the learning information is defined based on a contour area in the contour information and a belly part area in the belly part information.

5. The device for sorting an object to be sorted according to claim 4, wherein
the sorting means includes a plurality of ejectors operated based on the identification information, and
at least one of the number or an arrangement of the ejectors and the cell data have a predetermined relationship.
